(19) United States
(12) Patent Application Publication
(10) Pub. No.: US 2014/0038031 A1
(43) Pub. Date: Feb. 6, 2014

(54) CAP ASSEMBLY, BATTERY PACK INCLUDING THE SAME, AND METHOD OF MANUFACTURING THE BATTERY PACK

(71) Applicant: Samsung SDI Co., Ltd., Yongin-si (KR)

(72) Inventors: Jun-Sun Yong, Yongin-si (KR); Sang-Jin Lee, Yongin-si (KR); Yuny Trofimoy, Yongin-si (KR); Hyun-Wook Lee, Yongin-si (KR)

(73) Assignee: Samsung SDI Co., Ltd., Yongin-si (KR)

(21) Appl. No.: 13/938,212

(22) Filed: Jul. 9, 2013

(30) Foreign Application Priority Data
Aug. 6, 2012 (KR) 10-2012-0086001

(51) Int. Cl. H01M 2/04; H01M 10/04

(52) U.S. Cl. CPC H01M 2/0469; H01M 2/0404; H01M 10/04
USPC 429/175; 429/185; 264/272.21

(57) ABSTRACT

A cap assembly includes a protective circuit module; and an injection molded upper cap integral with the protective circuit module and configured to be coupled to an opening of a can housing an electrode assembly, wherein the upper cap comprises sealing portions that extend in a first direction away from the protective circuit module, and wherein the sealing portions are configured to contact an inner surface of the can.

### CROSS-REFERENCE TO RELATED APPLICATION

This application claims priority to and the benefit of Korean Patent Application No. 10-2012-0086001, filed on Aug. 6, 2012, in the Korean Intellectual Property Office, the disclosure of which is incorporated herein in its entirety by reference.

### BACKGROUND

1. Field

One or more embodiments of the present invention relate to a cap assembly, a battery pack including the same, and a method of manufacturing the battery pack.

2. Description of the Related Art

Unlike a primary battery that cannot be recharged, a secondary battery indicates a battery that can be discharged and recharged and is widely used in an energy storage system as well as a small-sized high-tech device, such as a mobile phone, personal digital assistant (PDA), laptop, or the like.

As various requirements of a secondary battery, such as high-power, high-capacity, or thinness, have been demanded, the number of components of the secondary battery has increased. In addition, according to such an increase in various requirements of the secondary battery, spacial limitation has increased and consequently cost has increased.

### SUMMARY

One or more embodiments of the present invention include a cap assembly, a battery pack including the same, and a method of manufacturing the battery pack.

Additional aspects will be set forth in part in the description which follows and, in part, will be apparent from the description.

According to one or more embodiments of the present invention, a cap assembly includes a protective circuit module; and an upper cap that is inject molded to form an all-in-one structure with the protective circuit module and that couples with an opening of a can, in which an electrode assembly is accommodated, wherein the upper cap includes sealing portions that extend in a first direction that is an opposite direction from a direction in which the protective circuit module is disposed, and that are in contact with an inner surface of the can.

The cap assembly may further include at least one connection tab that is electrically connected to the protective circuit module, wherein the upper cap is injected as the all-in one structure to surround the protective circuit module and at least a part of the connection tab.

The connection tab may extend in the first direction, and an end of the connection tab extended in the first direction is exposed to the outside by penetrating the upper cap.

The cap assembly may further include a temperature element disposed between the protective circuit module and the connection tab.

An electrolyte inlet penetrating the upper cap may be further included on one side of the upper cap, and the electrolyte inlet is closed by a stopper.

According to one or more embodiments of the present invention, a battery pack includes a can formed with an opening; an electrode assembly accommodated in the can through the opening; and a cap assembly closing the opening, wherein the cap assembly includes a protective circuit module; and an upper cap that is inject molded to form an all-in-one structure with the protective circuit module and that couples with the opening of the can, in which an electrode assembly is accommodated, and the upper cap includes sealing portions that extend in a first direction that is an opposite direction from a direction in which the protective circuit module is disposed, and that are in contact with an inner surface of the can.

A lower surface of the upper cap may be toward the inside of the can.

The lower surface of the upper cap may face an upper surface of the electrode assembly accommodated in the can.

The sealing portions may control movement of the electrode assembly.

Lower surfaces of the sealing portions may be in contact with the upper surface of the electrode assembly.

The sealing portions control movement of the electrode assembly by contacting the upper surface of the electrode assembly accommodated in the can while contacting the inner surface of the can.

The battery pack further includes at least one connection tab that is electrically connected to the protective circuit module, wherein the upper cap is injected as the all-in one structure to surround the protective circuit module and at least a part of the connection tab.

The battery pack further includes at least one connection tab that is electrically connected to the protective circuit module, wherein a first end of the connection tab is electrically connected to the protective circuit module, and a second end of the connection tab is electrically connected to the electrode assembly.

The battery pack further includes a temperature element disposed between the protective circuit module and the connection tab.

An electrolyte inlet penetrating the upper cap may be further included on one side of the upper cap, and the electrolyte inlet is closed by a stopper.

According to one or more embodiments of the present invention, a method of manufacturing a battery pack includes forming a cap assembly including a protective circuit module including external connection terminals on a first surface and an upper cap that is injected to form an all-in-one structure with the protective circuit module while exposing the external connection terminals, wherein the upper cap includes sealing portions that extend in a first direction that is an opposite direction from a direction in which the prospective circuit modules is disposed, and that are in contact with an inner surface of the can.

The forming of the cap assembly includes fixing the protective circuit module into a mold; injecting a resin material that forms the upper cap; and hardening the resin material.

The forming of the cap assembly further includes forming a connection tab, wherein a first end of the connection tab is electrically connected to the protective circuit module, and a second end of the connection tab extends in the first direction, and wherein the second end of the connection tab penetrates the upper cap.

The method further includes preparing a can in which an electrode assembly is accommodated; and closing an opening of the can by using the cap assembly.

The closing of the opening further includes closing the opening of the can such that the inner surface of the can where the opening is formed and outer surfaces of the sealing portions are in contact.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view schematically illustrating a disassembled battery pack according to an embodiment of the present invention;

FIG. 2A is an upper view of a cap assembly according to an embodiment of the present invention;

FIG. 2B is a lower view of the cap assembly according to an embodiment of the present invention;

FIG. 3 is a cross-sectional view along line of FIG. 2A;

FIGS. 4A through 4G schematically illustrate a method of manufacturing the battery pack, according to an embodiment of the present invention, wherein FIGS. 4A through 4C illustrate a method of manufacturing the cap assembly, according to an embodiment of the present invention, and FIGS. 4D through 4G illustrate a method after manufacturing the cap assembly to complete the manufacture of the battery pack;

FIG. 5 is a cross-sectional view along line V-V of FIG. 4G, which illustrates an inside section of the completed battery pack; and

FIG. 6 is a cross-sectional view of a cap assembly according to another embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description, and the scope of the invention is defined by the appended claims. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that although the terms “first” and “second” are used herein to describe various elements, these elements should not be limited by these terms. These terms are only used to distinguish one element from another element.

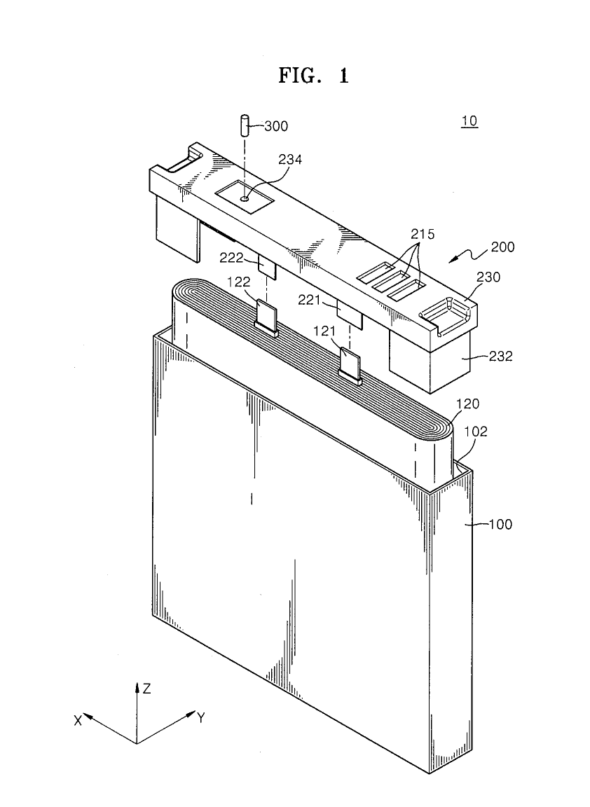

FIG. 1 is a perspective view schematically illustrating a disassembled battery pack 10 according to an embodiment of the present invention.

Referring to FIG. 1, the battery pack 10 may include an electrode assembly 120, a can 100, and a cap assembly 200.

The electrode assembly 120 may include a positive electrode plate and a negative electrode plate that are both coated with an electrode active material and a separator located between the positive and negative electrode plates. The electrode assembly 120 is a jelly-roll type electrode assembly which may be manufactured by sequentially stacking the negative electrode plate, the separator, and the positive electrode plate, and rolling the stack. According to another embodiment, the electrode assembly 120 may have a structure formed by only sequentially stacking the negative electrode plate, the separator, and the positive electrode plate. Each of the negative and positive electrode plates may be electrically connected to a negative electrode tab 121 and a positive electrode tab 122, respectively, to draw out electric charges that are formed by a chemical reaction.

The electrode assembly 120 may be stored in the can 100 with an impregnated electrolyte. After the electrode assembly 120 is stored, an opening 102 of the can 100 may be sealed by the cap assembly 200. The cap assembly 200 may be insert coupled to the opening 102, and the opening 102 of the can 100 may be closed due to the coupling of the cap assembly 200 with the can 100.

The cap assembly 200 is an independent component installed in the opening 102 of the can 100, wherein the cap assembly 200 may be formed in an all-in-one structure including a protective circuit module 210, first and second connection tabs 221 and 222, and an upper cap 230 surrounding the structure. The upper cap 230 of the cap assembly 200 may be formed by insert injection molding to surround the protective circuit module 210 and at least a part of the first and second connection tabs 221 and 222 that are electrically connected with the protective circuit module 210. For example, the cap assembly 200 may be formed by inserting and fixing the protective circuit module 210 and the first and second connection tabs 221 and 222 that are electrically connected to the protective circuit module 210 into a mold, injecting a melted resin material in the mold to expose lower ends of external connection terminals 215 of the protective circuit module 210 and then hardening the melted resin material. The upper cap 230, which is one of the components of the cap assembly 200 that is formed of a resin material, surrounds the protective circuit module 210 and at least a part of the first and second connection tabs 221 and 222.

Although an upper surface of the cap assembly 200 is mostly covered with the resin material, the external connection terminals 215 formed on an upper surface of the protective circuit module 210 are exposed through some openings of the upper surface of the cap assembly 200. Also, although a lower surface of the cap assembly 200 is mostly covered with the resin material, the first and second connection tabs 221 and 222 may be exposed extending downward through the lower surface of the cap assembly 200.

First ends of the first and second connection tabs 221 and 222 are each electrically connected to the protective circuit module 210, and second ends of the first and second connection tabs 221 and 222 are electrically connected to the negative and positive electrode tabs 121 and 122, respectively, via welding or the like. The electrode assembly 120 and the protective circuit module 210 may be electrically connected through the first and second connection tabs 221 and 222.

Sealing portions 232 are formed on the lower surface of the cap assembly 200, or more particularly, on a lower surface of the upper cap 230, and thus, prevent the cap assembly 200 coupled to the opening 102 of the can 100 from being separated from the can 100. The sealing portions 232 have an overall stepped shape from the cap assembly 200, wherein outer surfaces of the sealing portions 232 are in direct contact with an inner surface of the can 100 to press the inner surface of the can 100 with a predetermined pressure. Accordingly, the cap assembly 200 coupled through the sealing portions 232 does not separate from the can 100 and thus may prevent the electrode assembly 120 and the electrolyte included in the can 100 from leaking. In one embodiment, the outer surface of the can 100 and a part of the outer surface of the cap assembly 200 may be wrapped with a protective sheet, such as a label, after the cap assembly 200 is coupled with the opening 102 of the can 100.

An electrolyte inlet 234 may be formed on one side of the cap assembly 200. After the cap assembly 200 is coupled with the opening 102 of the can 100, the electrolyte is injected through the electrolyte inlet 234, and the electrolyte inlet 234 may be sealed with a stopper 300.

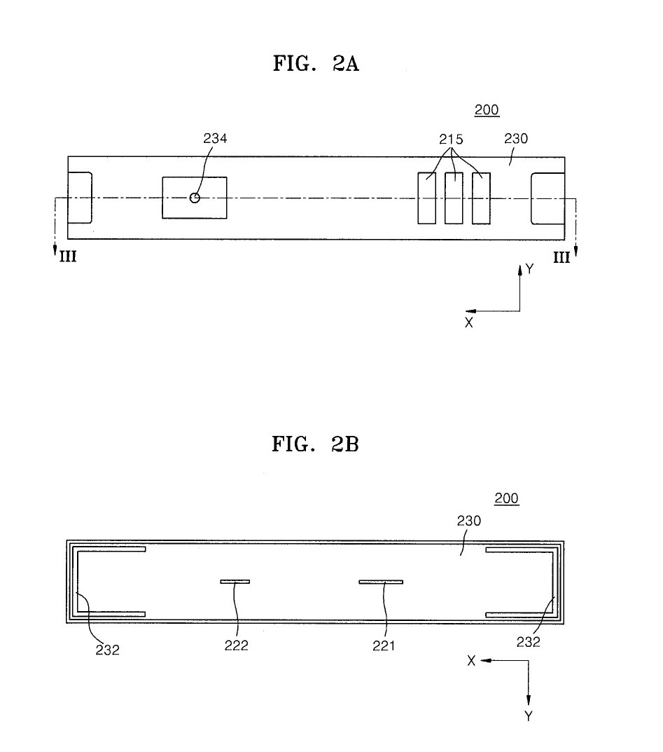

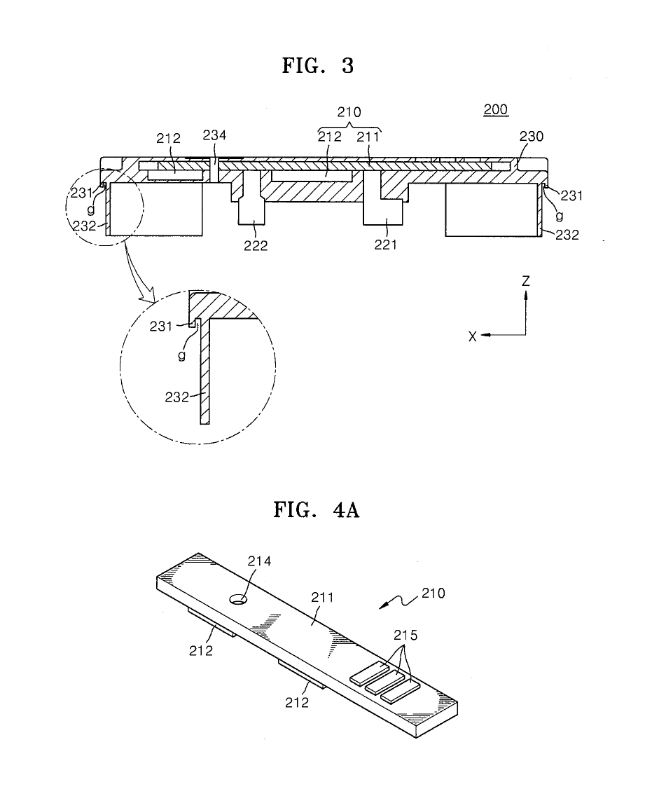

FIGS. 2A through 3 illustrate the cap assembly 200 shown in FIG. 1.

FIG. 2A is an upper view of the cap assembly 200 according to an embodiment of the present invention, and FIG. 2B is a lower view of the cap assembly 200 according to an embodiment of the present invention. FIG. 3 is a cross-sectional view along line of FIG. 2A.

Referring to FIG. 2A, the upper surface of the cap assembly 200 is mostly covered with an upper surface of the upper cap 230. That is, the upper surface of the cap assembly 200 is mostly covered with the resin material, and thus the external connection terminals 215 formed on the upper surface of the protective circuit module 210 may be exposed through some areas of the upper surface of the cap assembly 200. The electrode inlet 234 penetrating the cap assembly 200 (or the upper cap 230) is formed in the other region of the upper surface of the cap assembly 200.

Referring to FIG. 2B, the lower surface of the cap assembly 200 is mostly covered with the lower surface of the upper cap 230. That is, the lower surface of the cap assembly 200 is mostly covered with the resin material, and thus the first and second connection tabs 221 and 222 may extend to penetrate the lower surface of the cap assembly 200 to be exposed to the outside.

Referring to FIG. 3, the cap assembly 200 may include the protective circuit module 210, the first and second connection tabs 221 and 222, and the upper cap 230 surrounding the structure formed of a resin material. The resin material may be polyamide resin, polyethylene resin, polypropylene resin, or the like.

The protective circuit module 210 includes a substrate 211 and a plurality of protective circuits 212 mounted on the substrate 211. The protective circuits may control overcharge and overdischarge of the electrode assembly 120. The protective circuits may be implemented as a plurality of elements. For example, the substrate 211 may include integrated circuits and safety elements, such as a passive element, for example a resistor or a capacitor, and an active element, such as a field effect transistor.

The protective circuit module 210 is electrically connected to the electrode assembly 120 to control overcharge and overdischarge of the battery pack 10, and the connection therebetween is enabled through the electrical connections between the first tab 221 and the negative electrode tab 121 and between the second connection tab 222 and the positive electrode tab 122.

The first and second connection tabs 221 and 222 may extend downward (i.e., in a direction toward the opening 102 of the can 100) of the cap assembly 200 to be welded with the positive and negative electrode tabs 122 and 121 of the electrode assembly 120, respectively. The first end of the first connection tab 221 is electrically connected to the protective circuit module 210, and the second end of the first connection tab 221 may be exposed to the outside of the cap assembly 200 to be welded with the negative electrode tab 121. Also, the first end of the second connection tab 222 is electrically connected with the protective circuit module 210, and the second end of the second connection tab 222 may be exposed to the outside of the cap assembly 200 to be welded with the positive electrode tab 122.

The upper cap 230 is formed in an all-in-one structure with the protective circuit module 210 and the first and second connection tabs 221 and 222 to surround the protective circuit module 210 and at least a part of the first and second connection tabs 221 and 222. The upper cap 230 is formed to surround most of the protective circuit module 210, except the external connection terminals 215 formed on the upper surface of the protective circuit module 210. Thus, as shown in FIG. 2B, the protective circuit module 210 is not exposed through the lower surface of the cap assembly 200. Therefore, when the cap assembly 200 is coupled with the opening 102 of the can 100, an upper surface of the electrode assembly 120 accommodated in the can 100 faces the lower surface of the upper cap 230 formed of a resin material.

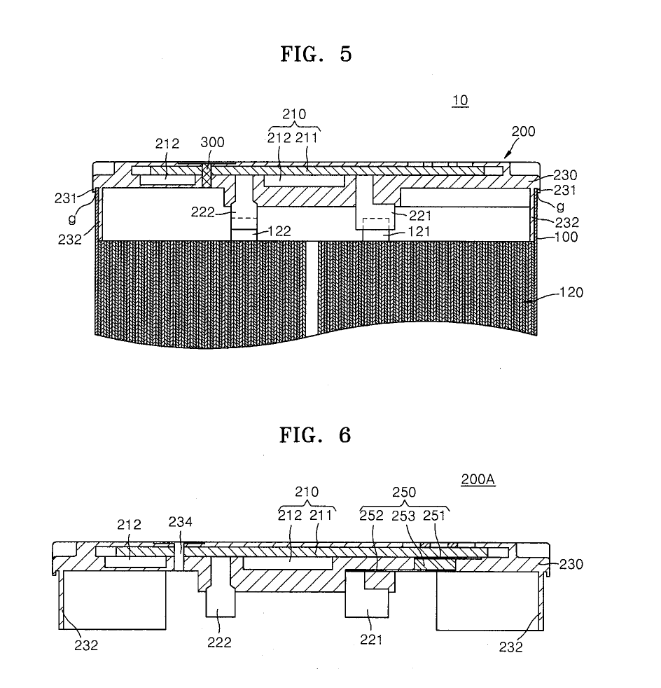

The sealing portions 232 extend downward from the lower surface of the upper cap 230, and as the outer surfaces of the sealing portions 232 directly contact the inner surface of the opening 102 of the can 100, the sealing portions 232 may have a stepped shape from the cap assembly 200. In greater detail, the sealing portions 232 are formed to have a stepped shape to outer walls 231 of the cap assembly 200, and thus grooves g may be formed in the cap assembly 200, that is, between the outer walls 231 of the cap 230 and the sealing parts 232. As will be described in FIG. 5, an upper part of the can 100 may be inserted in the grooves g.

The sealing portions 232 enable coupling of the cap assembly 200 with the can 100, and at the same time, can control movement of the electrode assembly 120 accommodated in the can 100. When the cap assembly 200 and the can 100 are coupled, the outer surfaces of the sealing portions 232 are in contact with the inner wall of the can 100, and lower surfaces of the sealing portions 232 are in contact with the upper surface of the electrode assembly 120. Thus the electrode assembly 120 moving inside the can 100 may be controlled. That is, if a total height of the electrode assembly 120 accommodated in the can 100 and one of the sealing portions 232 is substantially the same as a height of the can 100, the upper surface of the electrode assembly 120 is in contact with the lower surfaces of the sealing portions 232, and thus the movement of the electrode assembly 120 inside the can 100 may be controlled.

The electrolyte inlet 234 may be formed penetrating the cap assembly 200, and more particularly, the electrolyte inlet 234 is formed to penetrate one region of the upper cap 230. Since the electrolyte inlet 234 is formed to penetrate the cap assembly 200, the protective circuit module 210 may be formed shorter than a length of the whole cap assembly 200. The electrolyte inlet 234 may be sealed with a stopper 300 as stated above.

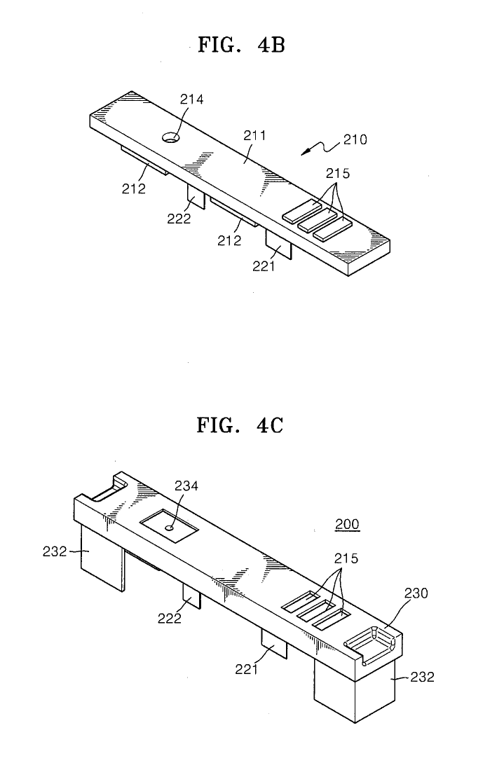

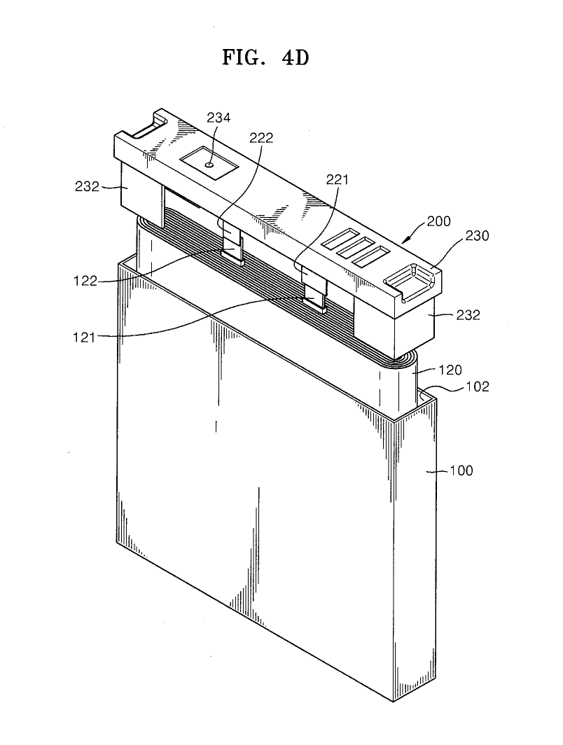

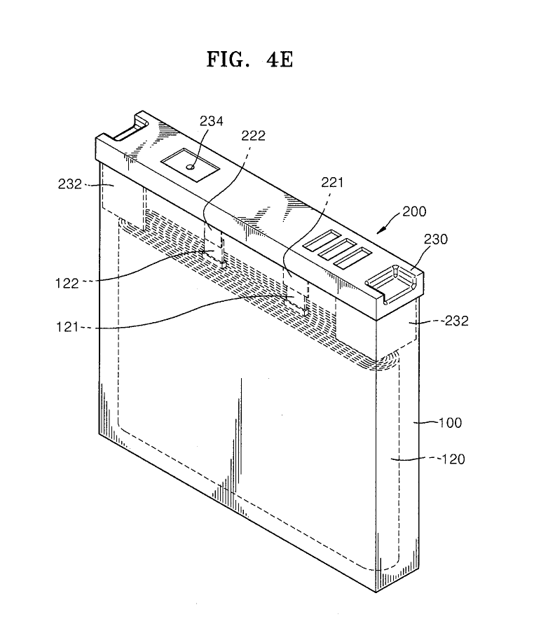

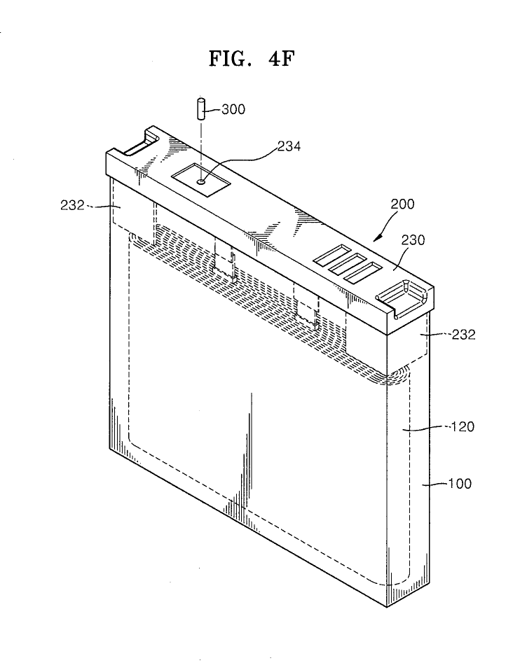

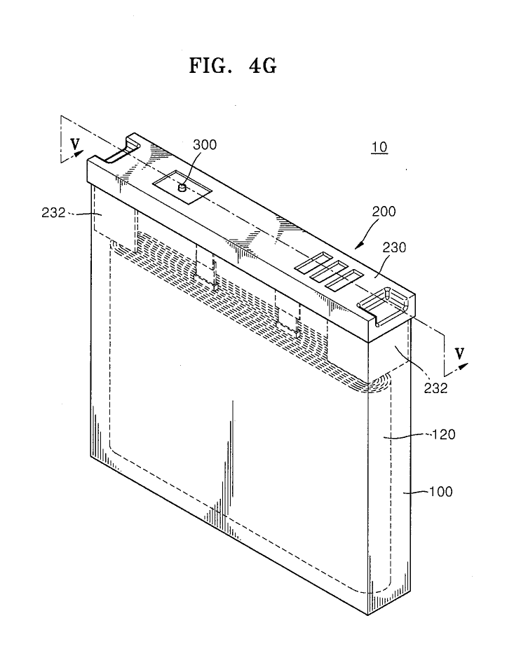

FIGS. 4A through 4G schematically illustrate a method of manufacturing the battery pack 10, according to an embodiment of the present invention. FIGS. 4A through 4C illustrate a method of manufacturing the cap assembly 200, according to an embodiment of the present invention, and FIGS. 4D through 4G illustrate a method after manufacturing the cap assembly 200 to complete the manufacture of the battery pack 10.

Referring to FIG. 4A, first, the protective circuit module 210 is prepared. The protective circuit module 210 may include the substrate 211 and the plurality of protective circuits 212 mounted on the substrate 211. The external connection terminals 215 for supplying electricity to an external electrical device are formed on one side of the upper surface of the protective circuit module 210. If a length of the protective circuit module 210 is relatively long, a hole 214 may be formed to penetrate a region corresponding to the electrolyte inlet 234 of the cap assembly 200. Alternatively, a length of the protective circuit module 210 may be shortened.

Referring to FIG. 4B, the protective circuit module 210 and the first and second connection tabs 221 and 222 are electrically connected. The first and second connection tabs 221 and 222 may be included as one pair and may be electrically connected to a rear surface of the protective circuit module 210 by welding or by using a reflow soldering method.

Referring to FIG. 4C, the protective circuit module 210, including the first and second connection tabs 221 and 222, is inserted into a molding space of the mold, and then a melted resin material is injected into the mold to perform an insert injection mold. Here, the first and second connection tabs 221 and 222 inserted in the molding space are oriented to extend in a direction opposite to a direction in which the external connection terminals 215 are exposed. As the injected melted resin material cools off, the upper cap 230, which surrounds the protective circuit module 210 and at least a part of the first and second connection tabs 221 and 222 and which includes the sealing part 232 extending in the same direction as the first and second connection tabs 221 and 222, is completed to form the cap assembly 200. As the melted resin material is cooled off to generally fix the locations of the protective circuit module 210 and the first and second connection tabs 221 and 222, the cap assembly 200 of an all-in-one type is completed.

Referring to FIG. 4D, the negative and positive electrode tabs 121 and 122 of the electrode assembly 120 stored in the can 100 are welded to the first and second connection tabs 221 and 222, respectively. For example, among the first and second connection tabs 221 and 222, the first connection tab 221 connected to a negative electrode of the protective circuit module 210 is welded to the negative electrode tab 121 of the electrode assembly 120, and the second connection tab 222 electrically connected to a positive electrode of the protective circuit module 210 is welded to the positive electrode tab 122 of the electrode assembly 120. Thus, the electrode assembly 120 and the protective circuit module 210 are electrically connected through respectively welding the first and second connection tabs 221 and 222 to the negative and positive electrode tabs 121 and 122.

Referring to FIG. 4E, the cap assembly 200 is coupled with the opening 102 of the can 100, in which the electrode assembly 120 is accommodated, by using the lower surface of the cap assembly 200. For example, the can 100 and the cap assembly 200 may be coupled by coating a material having an adhesive property on the inner wall of the can 100, inserting the cap assembly 200 in the can 100, and then applying a heat sealing method to the can 100 and the cap assembly 200. At this time, the sealing portions 232 formed on the lower surface of the cap assembly 200 are inserted into the can 100 as the outer surfaces of the sealing portions 232 are in contact with the inner wall of the can 100. The opening 102 of the can 100 may maintain airtightness by being sealed due to the coupling of the sealing portions 232 and the opening 102 of the can 100.

The lower surfaces of the sealing portions 232 inserted in the can 100 press the electrode assembly 120, by contacting the upper surface of the electrode assembly 120, and control the electrode assembly 120 moving inside the can 100.

Referring to FIG. 4F, the electrolyte is injected through the electrolyte inlet 234 formed in the cap assembly 200, and the electrolyte inlet 234 is blocked with the stopper 300, thereby completing the battery pack 10 as shown in FIG. 4G. The stopper 300 may be formed of a material, such as rubber or silicon.

In one embodiment, a label surrounding the can 100 and part of the cap assembly 200 may be further included if necessary.

FIG. 5 is a cross-sectional view along line V-V of FIG. 4G, which illustrates an inside section of the completed battery pack 10.

Referring to FIG. 5, the electrode assembly 120 is accommodated inside the can 100, and the inside of the can 100 is sealed as the opening 102 of the can 100 is coupled with the cap assembly 200. The upper part of the can 100 is inserted into the grooves g formed in the cap assembly 200 when the opening 102 of the can 100 and the cap assembly 200 are coupled. That is, the upper part of the can 100 is inserted into the grooves g that are formed between the outer walls 231 of the cap assembly 200 and the sealing portions 232. A width of the grooves g is formed substantially the same as or less than a thickness of the can 100, and the cap assembly 200 may be coupled with the can 100 as the upper part of the can 100 is coupled with the grooves g of the cap assembly 200. The lower surface of the cap assembly 200 (for example, the upper cap 230) faces the upper surface of the electrode assembly 120 due to the coupling of the can 100 and the cap assembly 200. Here, the lower surface of the cap assembly 200 is the lower surface of the upper cap 230 formed of a resin material.

The outer surfaces of the sealing portions 232 of the cap assembly 200 press the inner surface of the can 100, and the lower surfaces of the sealing portions 232 press the upper surface of the cap assembly 200, and thus, movement of the electrode assembly 120 inside the can 100 is prevented. In this regard, a sum of a height of the sealing portions 232 and a height of the electrode assembly 120 may be substantially the same as the height of the can 100.

FIG. 6 is a cross-sectional view of a cap assembly 200A according to another embodiment of the present invention.

Referring to FIG. 6, the cap assembly 200A according to another embodiment is also an independent component that is installed in an opening of a can 100. The cap assembly 200A may be formed as an all-in-one structure including a protective circuit module 210, first and second connection tabs 221 and 222, and an upper cap 230 surrounding the structure, in the same manner as described above for the cap assembly 200 with reference to FIGS. 2A through 3.

However, the cap assembly 200A according to the other embodiment of the present invention is different from the cap assembly 200 described above in that a temperature element 250 between the protective circuit module 210 and the first connection tab 221 is further included. Hereinafter, the difference of the cap assembly 200A will be mainly described.

The temperature element 250 is located between the protective circuit module 210 and the first connection tab 221. The temperature element 250 includes a main body 253 and first and second leads 251 and 252. The first lead 251 may be formed on one surface of the main body 253 and may be electrically connected to the protective circuit module 210. The second lead 252 may be formed on another surface of the main body 253 and may be electrically connected to the first connection tab 221.

The main body 253 may be manufactured by dispersing conductive particles in a crystalline polymer. The conductive particles may be carbon particles, and the crystalline polymer may be synthetic resin, such as polyolefin-based resin. The main body 253 connects a flow of current between the first lead 251 and the second lead 252 as the conductive particles are aggregated at a set temperature or less. However, when a temperature of the main body 253 increases to the set temperature or higher, the conductive particles are separated as the crystalline polymer expands, and thus a resistance rapidly increases. As a result, the flow of the current between the first lead 251 and the second lead 252 is blocked or a small amount of the current may flow therebetween. Accordingly, the main body 253 serves as a safety device that prevents rupture of a battery pack 10 by being electrically connected to the electrode assembly 120. Here, the temperature of the main body 253 increases higher than the set temperature caused by heat generated as the battery pack 10 is overcharged. Subsequently, when the main body 253 is cooled off again below the set temperature; the conductive particles are connected again as the crystalline polymer contracts, and thus a flow of current may occur.

As described above, according to the one or more of the above embodiments of the present invention, a cap assembly, and a battery pack enabled to maintain airtightness by using the cap assembly may be provided, and thus productivity may be improved, cost may be reduced. Also, a process of assembling the battery pack may be conveniently performed.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A cap assembly comprising:
a protective circuit module; and
an injection molded upper cap integral with the protective circuit module and configured to be coupled to an opening of a can housing an electrode assembly, wherein the upper cap comprises sealing portions that extend in a first direction away from the protective circuit module, and wherein the sealing portions are configured to contact an inner surface of the can.

2. The cap assembly of claim 1, further comprising at least one connection tab that is electrically connected to the protective circuit module, wherein the upper cap surrounds the protective circuit module and at least a portion of the connection tab.

3. The cap assembly of claim 2, wherein the connection tab extends in the first direction, and an end of the connection tab is exposed from the upper cap.

4. The cap assembly of claim 2, further comprising a temperature element located between the protective circuit module and the connection tab.

5. The cap assembly of claim 1, wherein an electrolyte inlet penetrating the upper cap is located on the upper cap, and wherein the electrolyte inlet is closed by a stopper.

6. A battery pack comprising:
a can having an opening;
an electrode assembly accommodated in the can; and
a cap assembly sealing the opening, wherein the cap assembly comprises:
a protective circuit module; and
an injection molded upper cap integral with the protective circuit module and coupled to the can, wherein the upper cap comprises sealing portions that extend in a first direction away from the protective circuit module, and wherein the sealing portions contact an inner surface of the can.

7. The battery pack of claim 6, wherein a lower surface of the upper cap faces an interior of the can.

8. The battery pack of claim 7, wherein the lower surface of the upper cap faces an upper surface of the electrode assembly.

9. The battery pack of claim 6, wherein the sealing portions are configured to control movement of the electrode assembly.

10. The battery pack of claim 6, wherein lower surfaces of the sealing portions contact an upper surface of the electrode assembly.

11. The battery pack of claim 10, wherein the sealing portions are configured control movement of the electrode assembly by contacting the upper surface of the electrode assembly accommodated in the can while contacting the inner surface of the can.

12. The battery pack of claim 6, further comprising at least one connection tab that is electrically connected to the protective circuit module, wherein the upper cap surrounds the protective circuit module and at least a portion of the connection tab.

13. The battery pack of claim 6, further comprising at least one connection tab that is electrically connected to the protective circuit module, wherein a first end of the connection tab is electrically connected to the protective circuit module, and a second end of the connection tab is electrically connected to the electrode assembly.

14. The battery pack of claim 13, further comprising a temperature element located between the protective circuit module and the connection tab.

15. The battery pack of claim 6, wherein an electrolyte inlet is on the upper cap, and wherein the electrolyte inlet is sealed by a stopper.

16. A method of manufacturing a battery pack, the method comprising:
forming a cap assembly comprising a protective circuit module comprising external connection terminals on a first surface and
injection molding an upper cap with the protective circuit module while exposing the external connection terminals, wherein the upper cap comprises sealing portions that extend in a first direction away from the protective circuit module, wherein the sealing portions contact an inner surface of the can.

17. The method of claim 16, wherein the forming of the cap assembly comprises:
fixing the protective circuit module into a mold;
injecting a resin material to form the upper cap; and
hardening the resin material.

18. The method of claim 16, wherein the forming of the cap assembly further comprises forming a connection tab, wherein a first end of the connection tab is electrically connected to the protective circuit module, and a second end of the connection tab extends in the first direction, and wherein the second end of the connection tab penetrates the upper cap.

19. The method of claim 18 further comprising:
inserting an electrode assembly into a can; and
sealing an opening of the can with the cap assembly.

20. The method of claim 19, wherein the sealing of the opening further comprises placing an outer surface of the sealing portions in contact with an inner surface of the can.
